(19) United States
(12) Patent Application Publication
(10) Pub. No.: US 2019/0219223 A1
(43) Pub. Date: Jul. 18, 2019

(54) ANGLE-ADJUSTABLE BRACKET OF VIDEO DOORBELL

(71) Applicant: Xianxue Zhou, Shenzhen (CN)

(72) Inventor: Xianxue Zhou, Shenzhen (CN)

(21) Appl. No.: 15/870,255

(22) Filed: Jan. 12, 2018

(51) Int. Cl. F16M 13/02; H04N 7/18; G08B 3/10

(52) U.S. Cl. CPC F16M 13/022; G08B 3/10; H04N 7/186

(57) ABSTRACT

The present invention discloses an angle-adjustable bracket of a video doorbell, including screws, nuts, a screw column, fixing grooves, female grooves, internal water outlets, an internal threading port, track grooves, male shafts, external water outlets, an external threading port, screw holes, a bracket base, a bracket cover and a doorbell, wherein the female grooves are formed in the bottom of the bracket base, the male shafts are arranged at the bottom of the bracket cover, the female grooves are rotationally connected with the male shafts, the doorbell is installed on one side of the bracket cover, the track grooves are formed in both sides of the bracket cover, the screws and the nuts are arranged in the track grooves, the external threading port is formed in the middle in the bracket cover, the screw holes are formed on the external threading port, and the internal threading port is formed in the bracket base. The angle-adjustable bracket of the video doorbell can adjust a desired angle according to the actual needs at any time, the desired angle is fixed by the screws, the bracket can be changed at any time, and thus great help is provided for people

### FIELD OF THE INVENTION

The present invention relates to the technical field of video doorbell accessories, and in particular to an angle-adjustable bracket of a video doorbell.

### BACKGROUND OF THE INVENTION

With the continuous improvement of the smart home product technology and the increasing improvement of the living standards of people, traditional doorbells are increasingly replaced by smart video doorbells. As a camera of a video doorbell is fixed to the doorbell, after the video doorbell is installed, the video area is fixed accordingly. The fixed video area cannot meet the needs of different installation environments. The known existing video doorbell angle bracket can only adjust the doorbell to a certain fixed angle, that is, can only adjust the video area of the video doorbells to a certain fixed area, but still cannot satisfy the different installation environments. When an ordinary doorbell is installed on a wall beside the door, the video angle of the doorbell can be seriously affected due to the fixed angle, and thus there is a certain video blind area. In the known prior art, the doorbell can only be fixed to a certain angle, and the video angle cannot be adjusted according to actual needs. An angle-adjustable bracket can adjusts the angle according to the actual needs, and the desired video angle is fixed by using screws. The existing fixed bracket can only be fixed to a certain angle, and thus cannot achieve adjustment according to the actual needs.

### SUMMARY OF THE INVENTION

The technical problem to be solved in the present invention is to overcome the existing shortcomings and provide an angle-adjustable bracket of a video doorbell in order to solve the above problems.

In order to achieve the above objective, the present invention provides the following technical solution: an angle-adjustable bracket of a video doorbell includes screws, nuts, screw columns, fixing grooves, female grooves, internal water outlets, an internal threading port, track grooves, male shafts, external water outlets, an external threading port, screw holes, a bracket base, a bracket cover and a doorbell, wherein the female grooves are formed in the bottom of the bracket base, the male shafts are arranged at the bottom of the bracket cover, the female grooves are rotationally connected with the male shafts, the doorbell is installed on one side of the bracket cover, the track grooves are formed in both sides of the bracket cover, the screws and the nuts are arranged in the track grooves, the external threading port is formed in the middle in the bracket cover, the screw holes are formed on the external threading port, the internal threading port is formed in the bracket base, the screw columns are arranged on an inner side of the bracket base, the fixing grooves are formed in one side in the bracket base, and the internal water outlets are formed in the lower ends of the fixing grooves.

As a preferred technical solution of the present invention, two screws and two nuts are provided in total, and the screws and the nuts are helically connected.

As a preferred technical solution of the present invention, the nuts are matched with the fixing grooves, and two fixing grooves are formed in total.

As a preferred technical solution of the present invention, two female grooves and two male shafts are provided in total, and the female grooves and the male shafts are rotationally connected.

As a preferred technical solution of the present invention, two internal water outlets and two external water outlets are formed in total.

As a preferred technical solution of the present invention, the screws and the nuts are made of a metal material.

Compared with the prior art, the present invention has the beneficial effects that the angle-adjustable bracket of the video doorbell can adjust the desired angle according to the actual needs at any time, the desired angle is fixed by the screws, and the bracket can be changed at any time without being repeatedly added, thereby saving materials and protecting the environment, one bracket can solve the problem, unnecessary waste is avoided, the material is film, durable and anti-oxidization, therefore there is no need to worry about exposure to the weather and sunshine, the video area of the video doorbell can be adjusted to different video areas at any time, the adjustment of different angles is achieved by using the rotating shaft principle, and the desired specific angle is fixed by using two screws, the structure is scientific and reasonable, the use is safe and convenient, and great help is provided for people.

### BRIEF DESCRIPTION OF THE DRAWINGS

The drawings are used for providing further understanding of the present invention, constitute a part of the specification, are used together with the embodiments of the present invention to explain the present invention, but do not limit the present invention. In the drawings:

FIG. 1 is a structural schematic diagram of an angle-adjustable bracket of a video doorbell in the present invention;

FIG. 2 is a structural schematic diagram of a bracket base in the present invention;

FIG. 3 is a structural schematic diagram of a bracket cover in the present invention; and

FIG. 4 is a side view of the angle-adjustable bracket of the video doorbell in the present invention;

Reference numbers: 1. screw; 2. nut; 3. screw columns, 4. fixing groove; 5. female groove; 6. internal water outlet; 7. internal threading port; 8. track groove; 9. male shaft; 10. external water outlet; 11. external threading port; 12. screw holes; 13. bracket base; 14. bracket cover; and 15. doorbell.

### DETAILED DESCRIPTION OF THE EMBODIMENTS

A clear and complete description of technical solutions in the embodiments of the present invention will be given below, in combination with the drawings in the embodiments of the present invention. Apparently, the embodiments described are merely a part, but not all, of the embodiments of the present invention. All of other embodiments, obtained by those of ordinary skill in the art based on the embodiments of the present invention without any creative effort, fall into the protection scope of the present invention.

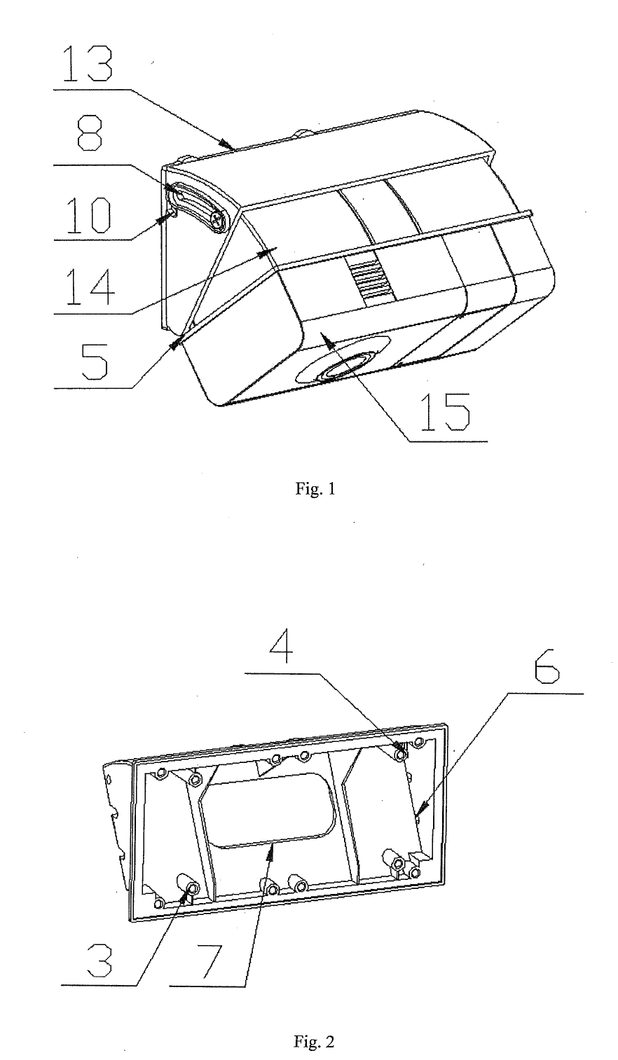

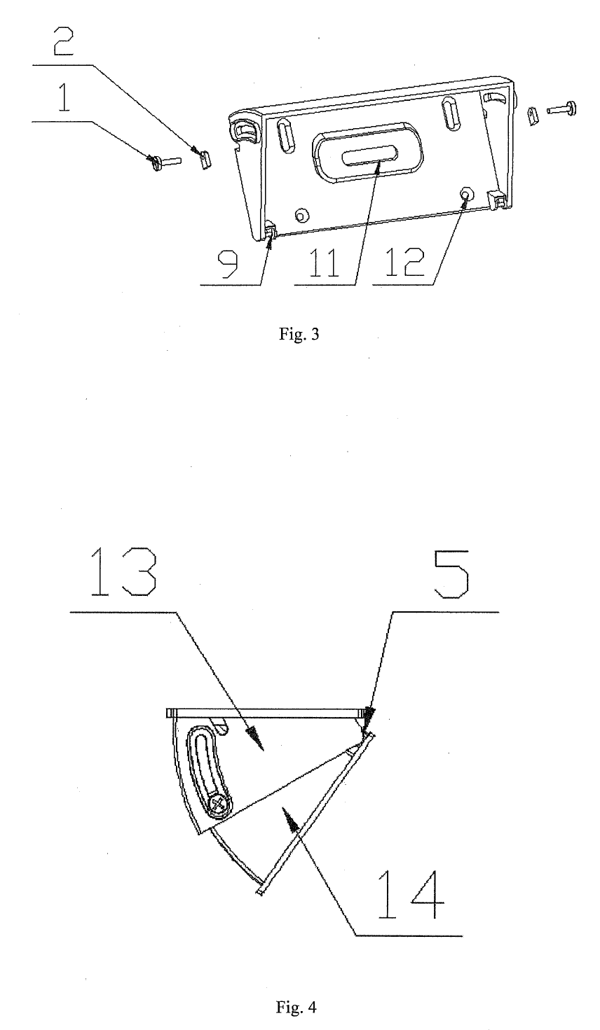

Referring to FIGS. 1 to 4, the present invention provides a technical solution: an angle-adjustable bracket of a video doorbell includes screws 1, nuts 2, screw columns 3, fixing grooves 4, female grooves 5, internal water outlets 6, an internal threading port 7, track grooves 8, male shafts 9, external water outlets 10, an external threading port 11, screw holes 12, a bracket base 13, a bracket cover 14 and a doorbell 15, wherein the female grooves 5 are formed in the bottom of the bracket base 13, the male shafts 9 are arranged at the bottom of the bracket cover 14, the female grooves 5 are rotationally connected with the male shafts 9, the doorbell 15 is installed on one side of the bracket cover 14, the track grooves 8 are formed in both sides of the bracket cover 14, the screws 1 and the nuts 2 are arranged in the track grooves 8, the external threading port 11 is formed in the middle in the bracket cover 14, the screw hole 12 is formed in a lower end of the external threading port 11, the internal threading port 7 is formed in the bracket base 13, screw columns 3 are arranged on an inner side of the bracket base 13, the fixing grooves 4 are formed in one side in the bracket base 13, and the internal water outlets 6 are formed in the lower ends of the fixing grooves 4. Two screws 1 and two nuts 2 are provided in total, the screws 1 and the nuts 2 are helically connected, the nuts 2 are matched with the fixing grooves 4, two fixing grooves 4 are formed in total, two female grooves 5 and two male shafts 9 are provided in total, the female grooves 5 and the male shafts 9 are rotationally connected, two internal water outlets 6 and two external water outlets 10 are formed in total, and the screws 1 and the nuts 2 are made of a metal material.

Specific principle: in use, the desired angle can be adjusted according to the actual need, the desired angle is fixed by using the screws 1, the internal water outlets 6 and the external water outlets 10 inside and outside can prevent water accumulation and avoid affecting the use of the doorbell, the external threading port 11 can shield excessive wires in the wall to prevent he wires from exposure to the outside, and the internal threading port 7 can provide an enough space for the wires and ensure the trimness of the wires inside.

The angle-adjustable bracket of the video doorbell can adjust the desired angle according to the actual needs at any time, the desired angle is fixed by the screws 1, and the bracket can be changed at any time without being repeatedly added, thereby saving materials and protecting the environment, one bracket can solve the problem, unnecessary waste is avoided, the material is firm, durable and anti-oxidization, therefore there is no need to worry about exposure to the weather and sunshine, the video area of the video doorbell can be adjusted to different video areas at any time, the adjustment of different angles is achieved by using the rotating shaft principle, and the desired specific angle is fixed by using two screws 1, the structure is scientific and reasonable, the use is safe and convenient, and great help is provided for people. Finally, it should be noted that described above are merely preferred embodiments of the present invention, which are not intended to limit the present invention. Although the present invention has been described in detail with reference to the foregoing embodiments, those skilled in the art can still make modifications to the technical solutions recorded in the foregoing embodiments or make equivalent substitutions to part of technical features thereof, and any modifications, equivalent substitutions, improvements and the like made within the spirit and principle of the present invention shall be encompassed within the protection scope of the present invention.

What is claimed and desired to be protected by Letters Patent is:

1. An angle-adjustable bracket of a video doorbell, comprising screws (1), nuts (2), screw columns (3), fixing grooves (4), female grooves (5), internal water outlets (6), an internal threading port (7), track grooves (8), male shafts (9), external water outlets (10), an external threading port (11), screw holes (12), a bracket base (13), a bracket cover (14) and a doorbell (15), wherein the female grooves (5) are formed in the bottom of the bracket base (13), the male shafts (9) are arranged at the bottom of the bracket cover (14), the female grooves (5) are rotationally connected with the male shafts (9), the doorbell (15) is installed on one side of the bracket cover (14), the track grooves (8) are formed in both sides of the bracket cover (14), the screws (1) and the nuts (2) are arranged in the track grooves (8), the external threading port (11) is formed in the middle in the bracket cover (14), screw holes (12) are formed on the external threading port (11), the internal threading port (7) is formed in the bracket base (13), screw columns (3) are arranged on an inner side of the bracket base (13), the fixing grooves (4) are formed in one side in the bracket base (13), and the internal water outlets (6) are formed in the lower ends of the fixing grooves (4).

2. The angle-adjustable bracket of the video doorbell of claim 1, wherein two screws (1) and two nuts (2) are provided in total, and the screws (1) and the nuts (2) are helically connected.

3. The angle-adjustable bracket of the video doorbell of claim 1, wherein the nuts (2) are matched with the fixing grooves (4), and two fixing grooves (4) are formed in total.

4. The angle-adjustable bracket of the video doorbell of claim 1, wherein two female grooves (5) and two male shafts (9) are provided in total, and the female grooves (5) and the male shafts (9) are rotationally connected.

5. The angle-adjustable bracket of the video doorbell of claim 1, wherein two internal water outlets (6) and two external water outlets (10) are formed in total.

6. The angle-adjustable bracket of the video doorbell of claim 1, wherein the screws (1) and the nuts (2) are made of a metal material.
